(19) United States
(12) Patent Application Publication
(10) Pub. No.: US 2024/0399476 A1
(43) Pub. Date: Dec. 5, 2024

(54) CUTTING DEVICE FOR CUTTING FLAT METAL PRODUCTS AND CUTTING SHEAR FOR CUTTING SAID FLAT METAL PRODUCTS EQUIPPED WITH SAID DEVICE

(71) Applicant: DANIELI & C. OFFICINE MECCANICHE S.P.A., Buttrio (IT)

(72) Inventors: Dmytro Lapin, Manzano (IT); Matteo Remy Bulfone, Colloredo di Monte Albano (IT)

(21) Appl. No.: 18/699,824

(22) PCT Filed: Oct. 10, 2022
(86) PCT No.: PCT/IB2022/059693

§ 371 Date: Apr. 9, 2024

(30) Foreign Application Priority Data
Oct. 11, 2021 (IT) 102021000025979

(51) Int. Cl. B23D 25/12; B23D 35/00

(52) U.S. Cl. CPC B23D 25/12; B23D 35/005

(57) ABSTRACT

A drum cutting device, e.g., for shears adapted to cut flat metal products advancing along a direction substantially parallel to their direction of longitudinal extension, said device being adapted to cut said flat metal products transversely relative to their direction of advancement, wherein said device comprises at least one drum adapted to be rotated and diametrically delimited by a cylindrical surface containing a blade or knife which partially protrudes from said cylindrical surface, wherein said blade or knife is partially housed in a seat of said drum and extends longitudinally along a direction substantially parallel to the rotation axis of said drum, wherein said device comprises an adjustment wedge also housed at least partially in said seat of said drum, wherein the direction of extension of said wedge is substantially parallel to the rotation axis of said drum and the thickness of said wedge transversely to its direction of extension varies continuously along said direction of extension from a minimum thickness to a maximum thickness, wherein said wedge is positioned relative to said blade or knife so that the translation of said wedge parallel to its direction of extension in a first direction of translation results in a peripheral tangential translation of said blade or knife in a first direction of peripheral tangential translation, while the translation of said wedge in a second direction of translation opposite to the first one results in the peripheral tangential translation of said blade or knife in a second direction of peripheral tangential translation opposite to the first one, said device comprising translation means for the translation of said wedge in said two opposite directions of translation.

### CROSS-REFERENCE TO RELATED APPLICATIONS

This application claims priority to PCT International Application No. PCT/IB2022/059693 filed on Oct. 10, 2022, which applications claims priority to Italian Patent Application No. 102021000025979 filed on Oct. 11, 2021, the entire disclosures of which are expressly incorporated herein by reference.

### STATEMENT RE: FEDERALLY SPONSORED RESEARCH/DEVELOPMENT

Not Applicable

### BACKGROUND

### Technical Field of the Invention

The present invention relates to the field of iron and steel industry; in particular, the present invention relates to the field of cutting flat metal products made, for example, by rolling and/or advanced by unwinding a previously rolled coil. In detail, the present invention relates to a cutting device for cutting said flat metal products during their advancement along a direction substantially parallel to their direction of longitudinal extension, said device comprising a rotating drum delimited by a cylindrical surface and equipped with a cutting blade or knife protruding from said cylindrical surface, wherein the rotation of said drum results in the impact of said blade or knife against said flat metal product and thus ultimately in the cutting of a said flat metal product transversely relative to its direction of advancement. The present invention relates, in particular, to a said cutting device comprising an innovative solution for adjusting the position of the blade, or knife, transversely to its direction of extension and thus tangentially to the drum.

It is a further object of the present invention a shear comprising at least one cutting device of the aforesaid type, wherein it is a further object of the present invention a method for cutting flat metal products transversely to their direction of advancement.

### Background Art

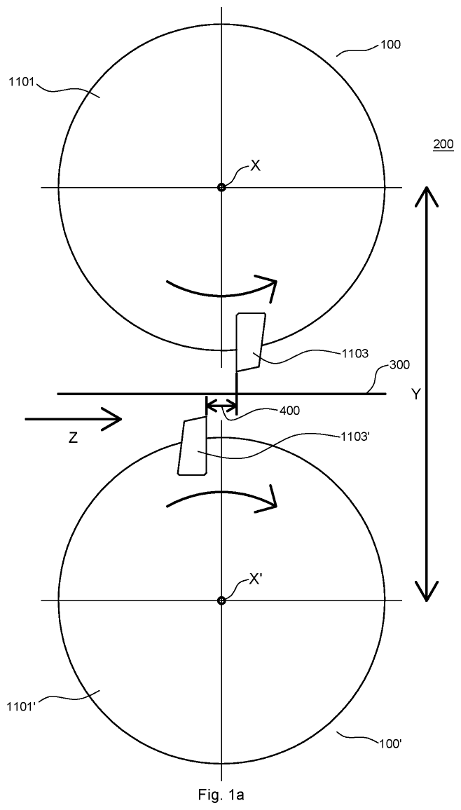

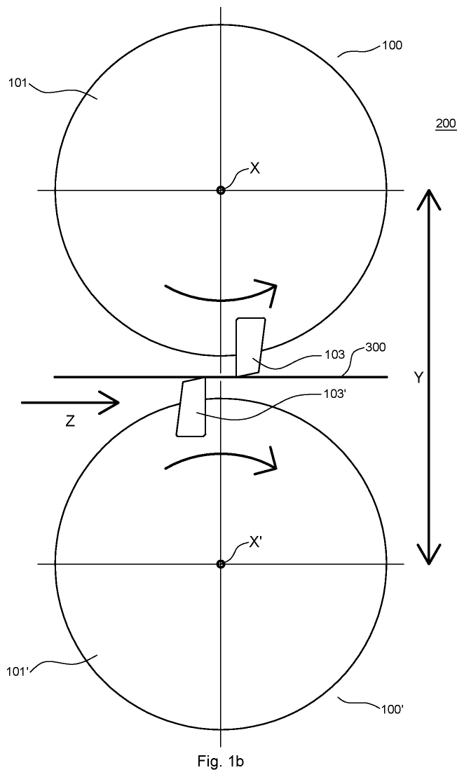

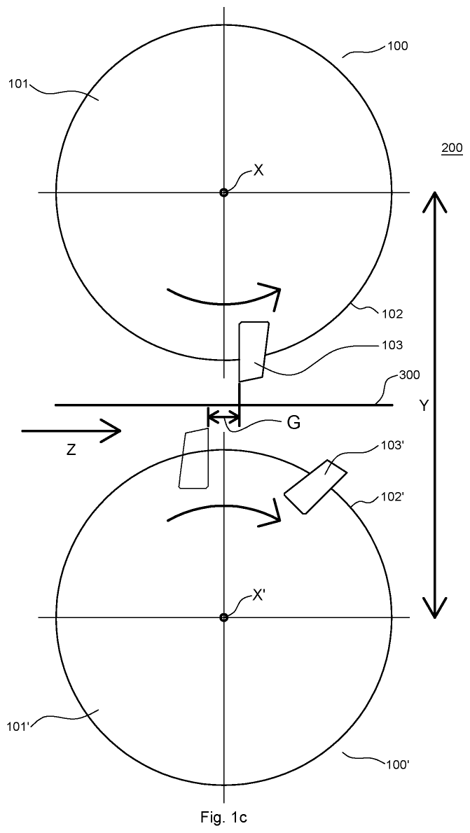

It is known in the prior art the use of rotating drum shears for cutting flat metal products advancing along a direction of advancement substantially parallel to the direction of longitudinal extension of said products, said shears being adapted to cut said flat metal products transversely relative to their direction of advancement. An example of a shear of a known type is shown in FIGS. 1a and 1b and comprises, as shown, a first rotating drum 1101 and a second rotating drum 1101′ adapted to be set into rotation each relative to own longitudinal axis of symmetry X and X′ respectively, in particular in opposite directions of rotation. Again, as shown, said first drum 1101 and second drum 1101′ are equipped with a blade or knife 1103 and 1103′, respectively, each of which protrudes from the cylindrical surface which radially delimits the drum to which it belongs, wherein the blade 1103 thus radially protrudes from the drum 1101, while the blade 1103′ radially protrudes from the drum 1101′.

Said first drum 1101 and second drum 1101′ (at least one of them) are translatable along a direction Y perpendicular to the rotation axes X and X′ between a first “open” position (FIG. 1a), in which the distance between the rotation axes X and X′ is maximum, and a “closed” position (FIG. 1b), in which the distance between the rotation axes X and X′ is minimum.

In FIGS. 1a and 1b, reference numeral 300 identifies a flat metal product, e.g., a strip of a predefined thickness (along the axis Y) and width (along the axes X and X′ and thus perpendicular to the plane of the figures), said strip coming, for example, from a rolling mill stand (not shown) or from the unwinding of a coil (not shown) and being advanced along the direction Z and thus parallel to its longitudinal extension direction (perpendicular to its width).

For cutting the strip 300 into portions of a predefined length, the end of the strip 300 is introduced into the space between the drum 1101 and the drum 1101′ in the open position, wherein the drums 1101 and 1101′ are then set into mutual rotation, approached, and positioned in the closed position (FIG. 1b), wherein the strip 300 is finally advanced along the direction Z. The strip 300 is run between the drums 1101 and 1101′ with linear speed synchronized with the peripheral speeds of the knives 1103 and 1103′ of the drums 1101 and 1101′, respectively, which approach each other by virtue of eccentric means, which allow the cutting before moving away mutually the two drums 1101 and 1101′ and the respective knives 1103 and 1103′ again from the transiting product 300.

Obviously, the rotation of the drums 1101 and 1101′ results in an impact, from above and from below, respectively, of the blades 1103 and 1103′ against the strip 300 and thus in the cutting of the strip 300 into portions.

In shears of the type described here with reference to FIGS. 1a and 1b, the need to cut strips 300 of different thicknesses results in the need to adjust the gap or distance 400 (in the direction Z) between the blade 1103 and the blade 1103′, wherein the gap 400 must be either increased or decreased to cut the strips 300 either thicker or thinner, respectively.

For this purpose, various solutions have been suggested and are still used in the shears according to the prior art, wherein said known solutions, however, display problems and/or disadvantages that the owner of the present patent application intended to overcome or at least minimize by means of the invention described and claimed below.

Indeed, the solutions according to the prior art for adjusting the gap between the blades are prevalently of the mechanical type and thus difficult to implement and prone to failure and/or breakage.

Furthermore, the solutions of the known type for adjusting the gap 400 require the shear be set in a stopped state, wherein gap adjustment times (and thus shear stop times) are often incompatible with production needs because they usually require manual intervention.

Finally, the disadvantages of the solutions of the known type include the fact that they do not allow the gap 400 to be adjusted with the necessary precision, having a limited adjustment range, and do not guarantee that the gap 400 as it is set will be maintained (does not change unintentionally) for all the planned production cycles, wherein, on the contrary, an adjustment of the desired and/or required gap is often required during the process.

Therefore, it is the main purpose of the present invention to overcome or at least minimize the problems summarized above and encountered in the prior art with an automatic or at least semiautomatic gap adjustment, in particular by having the shear in-line, and thus avoiding manual intervention.

In particular, it is a first purpose of the present invention to make available a solution for adjusting the gap between the blades of an opposed rotary drum shear which is implementable at low cost and through simple and fast operations on shear drums of various types and sizes.

It is a second purpose or objective of the present invention also to make available a solution of the aforesaid type which allows the gap to be adjusted in times compatible with production requirements.

Finally, it is a further non-secondary purpose of the present invention to make available a solution for adjusting the gap between the blades of an opposed rotary drum shear which guarantees a precise and long-lasting adjustment of said gap, and thus does not require in-process readjustments of the gap as previously set and adjusted.

### DESCRIPTION OF THE PRESENT INVENTION

The present invention is based on a concept according to which the drawbacks found in the prior art and summarized above can be effectively overcome or at least minimized by means of hydraulic, rather than mechanical, means of gap adjustment.

As set out below, the general concept mentioned above provides a very simple conformation of the gap adjustment means, wherein the implementation of said hydraulic-type adjustment means thus is particularly simplified and straightforward.

In view of the above, as well as of the problems and/or drawbacks encountered in the opposed rotating drum shears according to the prior art, the present invention relates to a cutting device according to claim 1, a cutting method according to claim 10, and an opposed rotating drum shear according to claim 12, wherein further embodiments of device, of the method and of the shear according to the present invention are defined by the dependent claims.

According to a first embodiment of the invention, a drum cutting device, e.g., for shears adapted to cut flat metal products advancing along a direction substantially parallel to their direction of longitudinal extension, said device being adapted to cut said flat metal products transversely relative to their direction of advancement, comprises at least one drum adapted to be rotated and diametrically delimited by a cylindrical surface and containing a blade or knife which partially protrudes from said cylindrical surface, wherein said blade or knife is partially housed in a seat of said drum and extends longitudinally along a direction substantially parallel to the rotation axis X of said drum, wherein said device comprises an adjustment wedge also housed at least partially in said seat of said drum, wherein the direction of extension of said wedge is substantially parallel to the rotation axis X of said drum and the thickness of said wedge transversely to its direction of extension varies continuously along said direction of extension from a minimum thickness to a maximum thickness, wherein said wedge is positioned relative to said blade or knife so that the translation of said wedge parallel to its direction of extension in a first direction of translation results in a peripheral tangential translation, in particular in a peripheral circumferential translation, of said blade or knife in a first direction of peripheral tangential translation TP1, in particular in a first direction of peripheral circumferential translation, while the translation of said wedge in a second direction of translation opposite to the first one results in the peripheral tangential translation, in particular in a peripheral circumferential translation, of said blade or knife in a second direction of peripheral tangential translation TP2, in particular in a second direction of peripheral circumferential translation, opposite to the first one, said device comprising translation means for the translation of said wedge in said two opposite directions of translation, wherein said translation means are arranged aboard said drum, and are of the hydraulically actuated type and adapted to subject the opposite ends of said wedge to the pressure of a hydraulic fluid.

Preferably, said translation means of the hydraulically actuated type are arranged inside, preferably completely inside, the drum.

In a variant, said translation means comprise a hydraulic circuit comprising, in turn, a first chamber and a second chamber positioned at a first end and a second end, respectively, of said adjustment wedge, wherein the introduction of a pressurized hydraulic fluid into said first chamber or said second chamber thus results in the translation of said wedge in said first direction of translation or said second direction of translation, respectively.

In a further variant, said device comprises a first thrust element and a second thrust element housed in said first chamber and said second chamber, respectively, so that the introduction of said pressurized hydraulic fluid into said first chamber or said second chamber results respectively in the translation of said first thrust element or said second thrust element and thus respectively in a thrust against said first end of said wedge by said first thrust element in said first direction of translation or in a thrust against said second end of said wedge by said second thrust element in said second direction of translation.

In a variant, said first and second chambers are placed in communication with the outside of said device respectively by means of a first hydraulic duct and a second hydraulic duct obtained at least partially inside said drum, and wherein said first hydraulic duct and said second hydraulic duct thus lead respectively into a first hydraulic port and a second hydraulic port accessible from the outside of said drum for the introduction of a pressurized hydraulic fluid respectively into said first chamber and said second chamber and for the discharge of said hydraulic fluid respectively from said first chamber and said second chamber.

In a further variant of said first hydraulic port and second hydraulic port are positioned on a rotating joint adapted to support rotating parts of said device.

In a variant, said first and second chambers are placed in communication with the outside of said device also respectively by means of a third hydraulic duct and a fourth hydraulic duct obtained at least partially inside said drum, wherein thus said third hydraulic duct and said fourth hydraulic duct lead respectively into a third hydraulic port and a fourth hydraulic port accessible from the outside of said drum for the introduction of a pressurized hydraulic fluid respectively into said first chamber and said second chamber and for the discharge of said hydraulic fluid respectively from said first chamber and said second chamber.

In a further variant, said third hydraulic port and fourth hydraulic port are positioned on a rotating part of the hub of said device different from said rotating joint.

Preferably, said device comprises an indicator of the position of said wedge inside the drum.

According to a first embodiment, a method for cutting flat metal products advancing along a direction substantially parallel to their direction of longitudinal extension is performed by a device by means of which said flat metal products are cut transversely relative to their direction of advancement, wherein said device is a device according to any one of the embodiments of the present invention, thus wherein the rotation of said at least one drum results in the impact of said blade or knife against a said flat metal product and thus ultimately in the cutting of said a flat metal product transversely to its direction of advancement, and wherein the translation of said wedge in said two opposite directions of translation is achieved by means of said hydraulic type translation means arranged aboard said drum.

In a variant, the translation of said wedge in said two opposite directions of translation is achieved by introducing a pressurized hydraulic fluid into said first chamber and/or respectively said second chamber.

According to a first embodiment, a drum shear for cutting flat metal products advancing along a direction substantially parallel to their direction of longitudinal extension, said shear being adapted to cut said products transversely relative to their direction of advancement, comprises a first cutting device and a second cutting device comprising respectively a first drum and a second drum, diametrically delimited respectively by a first cylindrical surface and a second cylindrical surface, and a first blade or knife and a second blade or knife fixed respectively to said first drum and to said second drum and protruding respectively from said first drum and from said second drum, wherein said first device and second device are reciprocally positioned to define a space for the passage of said flat metal products during their advancement, wherein with said first device and said second device appropriately positioned, the rotation of said first drum and said second drum results in the cutting of said flat metal product by means of the substantially simultaneous action of said first blade and said second blade; wherein said first device is a device according to any one of the embodiments of the present invention.

In a variant of the shear, at least one of said first device and second device is translatable along a direction of translation Y perpendicular to the rotation axis X of the respective first drum or away from and towards said second device.

In a further variant of the shear, the gap between the said first knife and second knife is adjustable to be equal to or greater than 0.00 mm, so that even very thin strips (e.g., 0.8 mm) can be cut.

### BRIEF DESCRIPTION OF THE DRAWINGS

Hereafter, the present invention will be further clarified by means of the following detailed description of the possible embodiments depicted in the drawings, in which corresponding or equivalent features and/or component parts of the present invention are identified by the same reference numerals. It must be noted that the present invention is not limited to the embodiments described hereafter and shown on the accompanying drawings; on the contrary, all the variants and/or changes to the embodiments described below and shown on the accompanying drawings which will appear obvious and immediate to a person skilled in the art are comprised in the scope of the present invention.

### In the Drawings:

FIGS. 1a and 1b each show a side view of an opposed rotating drum shear according to prior art;

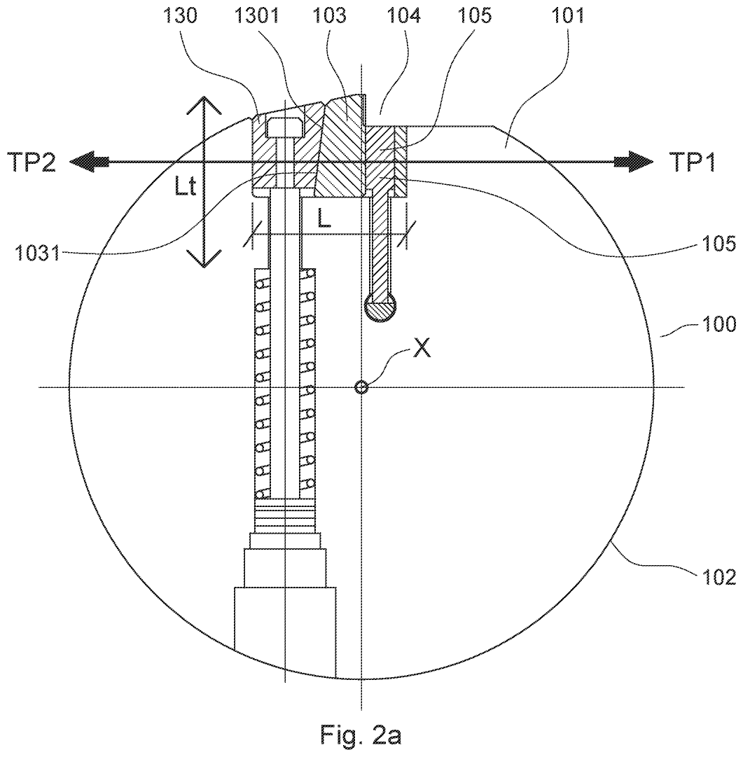

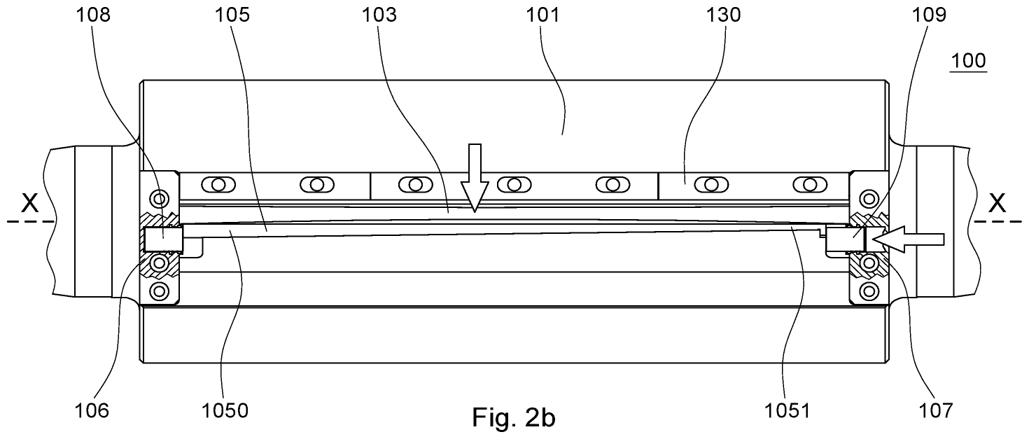

FIGS. 1c and 2a show side views of a shear according to an embodiment and a respective rotating drum cutting device according to an embodiment;

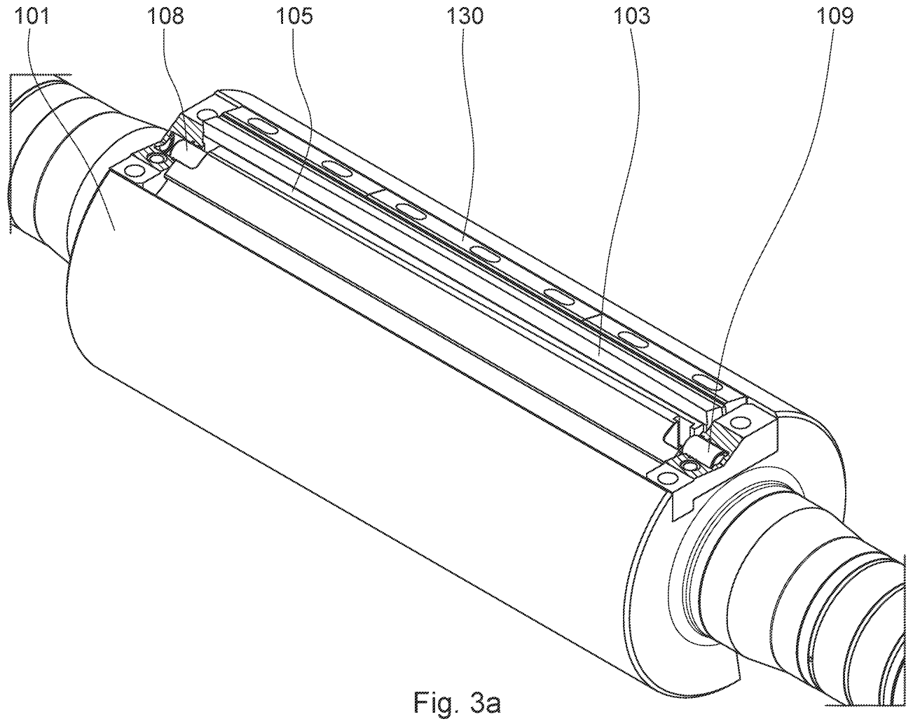

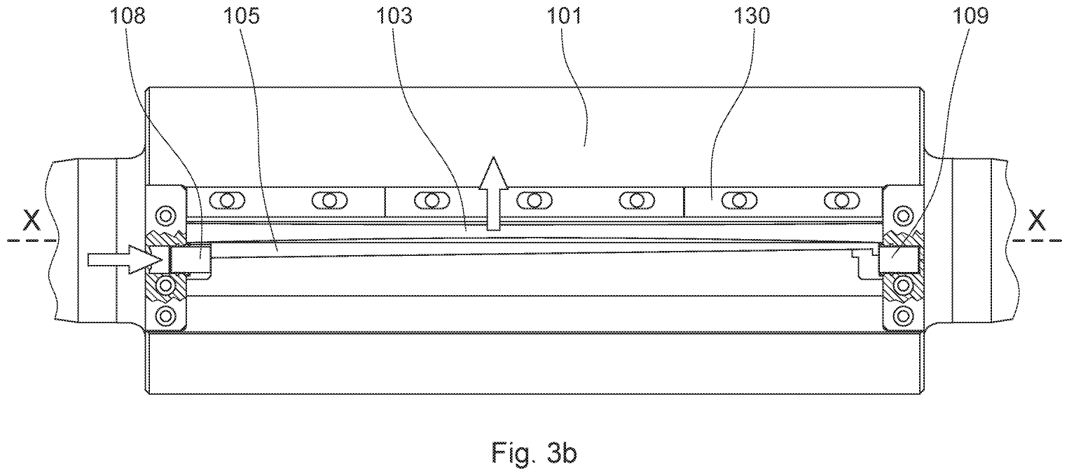

FIGS. 2b, 3a and 3b each shows a perspective view of a rotating drum cutting device according to an embodiment;

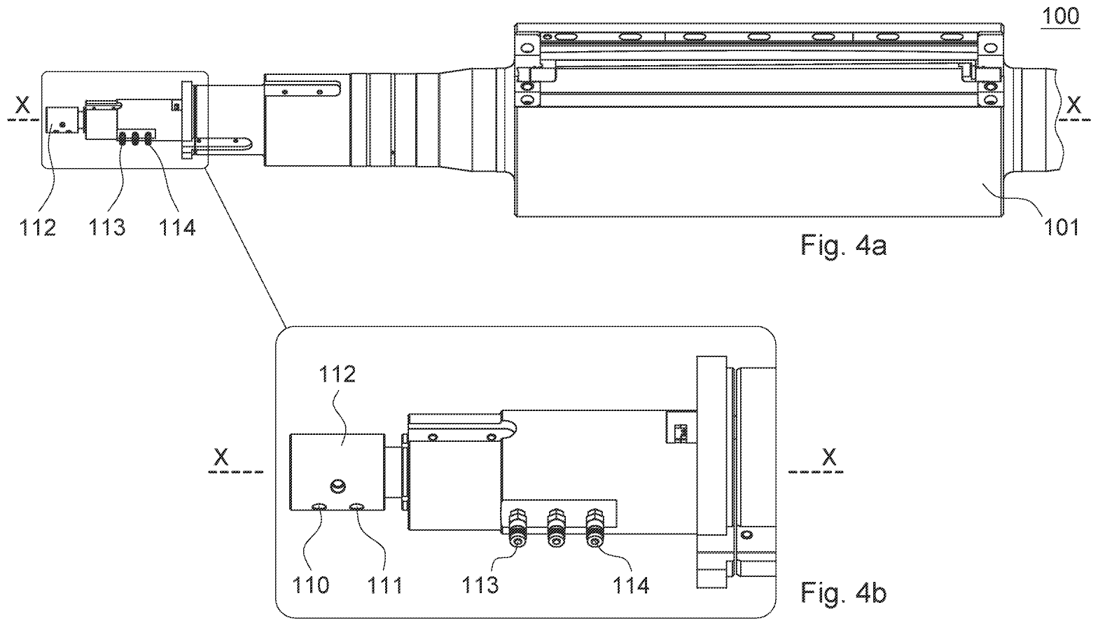

FIGS. 4a and 4b show a side view and an enlargement of a cutting device according to an embodiment, respectively;

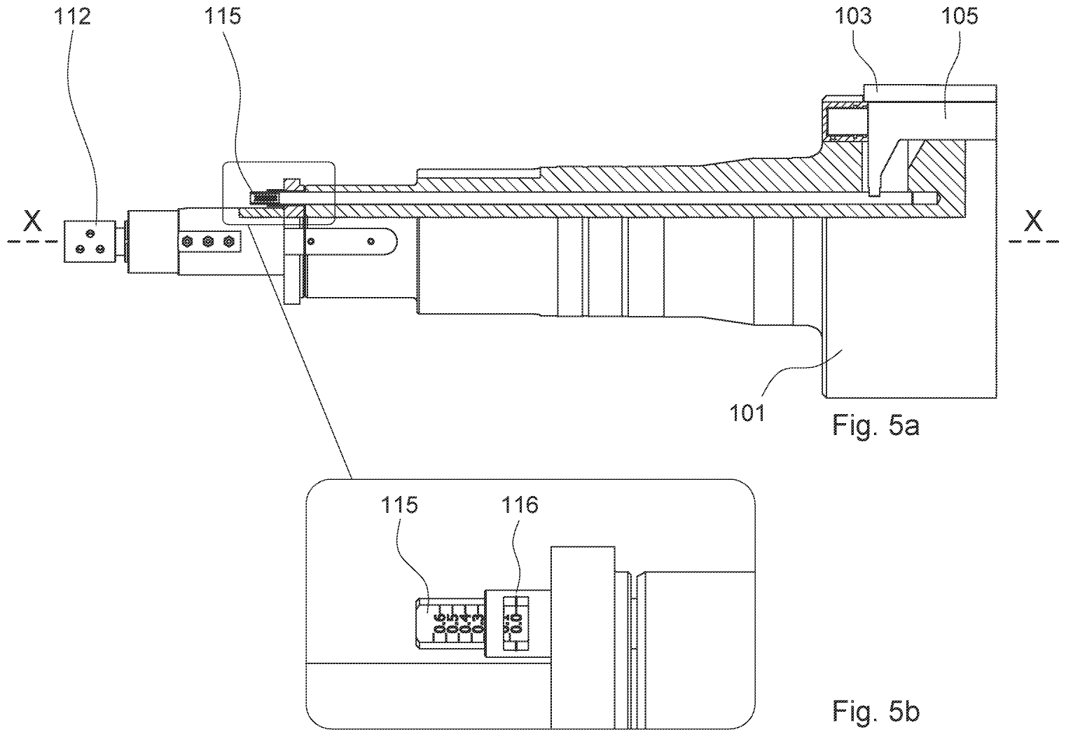

FIGS. 5a and 5b show a side view and an enlargement of a cutting device according to an embodiment, respectively.

### DETAILED DESCRIPTION OF THE PRESENT INVENTION

The present invention is particularly applied in the field of cutting of flat metal products, e.g., metal strips of various thicknesses, this being the reason for which the present invention is described hereafter with particular reference to its applications in the field of systems of the aforesaid type.

However, it is worth specifying that the possible applications of the present invention are not limited to those described below. Conversely, the present invention is conveniently applied in all cases in which it is necessary to cut an elongated metal (but possibly also plastic) element into portions of less than its total length.

According to the embodiment shown in FIGS. 1c and 2a, a shear 200 of the present invention comprises a first drum 101 and a second drum 101′ equipped with a first knife 103 and a second knife 103′, respectively, which protrude from the cylindrical surface 102 of the first drum 101 and from the cylindrical surface 102′ of the second drum 101′, respectively, in a manner known and thus not described in detail for the sake of brevity. However, for the sake of completeness of exposition it is clarified that for the purposes of the present invention it is sufficient for the cutting edge of the first knife 103 and the second knife 103′ to protrude radially from the surface 102 and the surface 102′, respectively.

The reciprocal position of the drums 101 and 101′ is adjustable along the direction Y between an open position (FIG. 1c) and a closed position (not shown) in the manner substantially described above, wherein the drums 101 and 101′ are adapted to be set in rotation relative to their respective longitudinal axes X and X′, respectively.

The cutting device 100 according to the embodiment in FIG. 2a comprises the first drum 101 and comprises as shown a blade or knife 103, which partially protrudes, in particular the cutting edge of which partially protrudes, in a radial direction from the cylindrical surface 102, which radially delimits the drum 101, wherein said blade or knife 103 is partially housed in a seat 104 of said drum 101 and extends longitudinally along a direction substantially parallel to the rotation axis X of the drum 101.

The seat 104 extends (FIG. 2a) in a first direction radially from the surface 102 towards the inside of the drum 101, in a second direction parallel to axis X, and in a third direction has a width L such to accommodate not only the blade 103 but also a wedge 105 and a locking element 130 arranged on opposite sides of the wedge 105 in the direction of the width L, wherein both the wedge 105 and the locking element 130 have longitudinal extension parallel to the axis X and thus to the longitudinal extension of the seat 104.

The locking element 130 has an inclined surface 1301 placed against an inclined surface 1031 of the knife 103 parallel to the surface 1301, wherein the locking element 130, by means not shown and not within the scope of the present invention (and thus not described in detail for the sake of brevity), is translatable along a direction Lt transverse to the direction of the width L of the seat 104, the element 130 being translatable in the two opposite directions of translation as indicated by the double arrow in FIG. 2a. From the description and from simple observation of FIG. 2a, it can be seen that the upward translation of the element 130 relative to the figure, and thus towards the outside of the seat 104, results in a decrease in the thrust of the surface 1301 against the surface 1031, and thus in a decrease in the pressure of the blade 103 against the wedge 105, and thus ultimately in the unlocking of the blade 103 and the possibility of adjusting the position of the blade within the seat 104 in the manner described below. Conversely, the downward translation of the element 130 relative to the figure, and thus towards the inside of the seat 104, results in an increase in the thrust of the surface 1301 against the surface 1031, and thus in an increase in the pressure of the blade 103 against the wedge 105, and thus ultimately in the locking of the blade 103 in its predetermined position.

The manners of adjusting the tangential or circumferential position of the blade 103 inside the seat 104 are described below with reference to FIGS. 2b, 3a and 3b.

First of all, it must be noted that the thickness of the adjustment wedge 105 transverse to its direction of extension varies continuously along said direction of extension from a minimum thickness to a maximum thickness (refer for this purpose, for example, to FIG. 3b, which shows the wedge 105 with greater thickness on the left of the figure and smaller thickness on the right of the figure). It can thus be inferred that, with the element 130 in the unlocking position, and thus with the knife 103 free to be translated, the translation of said wedge 105 parallel to its direction of extension in a first direction of translation from the right leftwards (with reference to FIG. 2b) results in a peripheral tangential translation, in particular in a peripheral circumferential translation, or at least in the possibility of translating the blade or knife 103 (e.g., by retracting the element 130 into a locking position) in a first direction of peripheral tangential translation TP1, in particular in a first direction of peripheral circumferential translation, and thus in a decrease of the gap G; on the contrary, the translation of said wedge 105 in a second direction of translation, opposite to the first one, from the left rightwards (with reference to FIG. 3b) results in the peripheral tangential translation, in particular in a peripheral circumferential translation, of said blade or knife 103 in a second direction of peripheral tangential translation TP2, in particular in a second direction of peripheral circumferential translation, opposite to the first direction, and thus in the increase of the gap G, wherein the re-entry of the block 130 towards the inside of the seat 104 and up to assume the new locking position (with contrast between surfaces 1301 and 1031) results in the locking of the blade 103 in the position defined by the wedge 105.

The device 100 according to the embodiment shown comprises translation means for the translation of said wedge 105 in said two opposite directions of translation, wherein a first important peculiarity of the device 100 is that said translation means are arranged aboard said drum 101.

Furthermore, a second peculiarity of the device 100 relates to the fact that said translation means are of the hydraulically actuated type and adapted to subject the opposite ends of said wedge 105 to the pressure of a hydraulic fluid.

Preferably, said hydraulic-type translation means are arranged inside, preferably completely inside, the drum 101.

In a variant, said translation means comprise a hydraulic circuit (not fully shown because it is partially formed inside said drum 101), said hydraulic circuit comprising, in turn, a first chamber 106 and a second chamber 107 in communication with said hydraulic circuit and positioned at a first end 1050 and a second end 1051, respectively, of said adjustment wedge 105, wherein thus the introduction of a pressurized hydraulic fluid into said first chamber 106 or said second chamber 107 results in the translation of said wedge 105 in said first direction of translation or said second direction of translation, respectively.

As clearly shown in FIGS. 2b and 3b, the first chamber 106 and the second chamber 107 are arranged inside the drum 101.

Furthermore, in order to improve the thrust by the oil or hydraulic fluid against the ends 1050 and 1051 of the wedge 105, a first movable thrust element 108 and a second movable thrust element 109, e.g., both substantially cylinder-shaped, are preferably respectively housed in the chambers or cavities 106 and 107, wherein the introduction of said pressurized hydraulic fluid into said first chamber 106 or said second chamber 107 (also, for example, substantially cylinder-shaped) results in translating said first thrust element 108 or said second thrust element 109, respectively, and thus in a thrust against said first end 1050 of said wedge 105 by said first thrust element 108 in said first direction of translation or in a thrust against said second end 1051 of said wedge 105 by said second thrust element 109 in said second direction of translation.

According to an embodiment shown in FIGS. 4a and 4b, said first and second chambers 106, 107 are placed in communication with the outside of said device 100 respectively by means of a first hydraulic duct and a second hydraulic duct obtained at least partially inside said drum 101 (and thus not shown), wherein said first hydraulic duct and said second hydraulic duct lead respectively into a first hydraulic port 110 and a second hydraulic port 111 accessible from the outside of said drum 101 for the introduction of a pressurized hydraulic fluid into said first chamber 106 and said second chamber 107, respectively, and for the discharge of said hydraulic fluid from said first chamber 106 and said second chamber 107, respectively.

According to an embodiment, said first hydraulic port 110 and second hydraulic port 111 are positioned on a rotating joint 112 adapted to support rotating parts of said device 100.

According to a further embodiment, said first and second chambers 106, 107 are placed in communication with the outside of said device also by means of a third hydraulic duct and a fourth hydraulic duct, respectively, obtained at least partially inside said drum 101 (and thus also not shown), wherein said third hydraulic duct and said fourth hydraulic duct respectively lead into a third hydraulic port 113 and a fourth hydraulic port 114 accessible from the outside of said drum 101 for the introduction of a pressurized hydraulic fluid into said first chamber 106 and said second chamber 107, respectively, and for the discharge of said hydraulic fluid from said first chamber 106 and said second chamber 107, respectively. Said third hydraulic port 113 and fourth hydraulic port 114 can be provided either as an alternative to said first hydraulic port 110 and second hydraulic port 111 or in addition to hydraulic ports 110 and 111, wherein in this case, according to the contingent needs, the hydraulic fluid can be fed into chambers 106 and 107 using ports 110 and 111 or alternatively ports 113 and 114.

According to a further variant, said third hydraulic port 113 and fourth hydraulic port 114 are positioned on a rotating part of the hub of said drum101 different from said rotating joint 112.

Preferably, the device 100 comprises an indicator of the position in the longitudinal direction of said wedge 105 housed inside the drum 101. In particular, said indicator comprises a bar 115 (FIGS. 5a-5b) connected, at a first end thereof, to an end 1050 of the wedge 105; the second end of bar 115, opposite to the first end, being graduated and visible from the outside and positioned at reference marks 116 also visible from the outside of the drum 101. Alternatively, electro-mechanical indicators of the position of the wedge 105, e.g., comprising a transducer, can be provided.

The cutting manner of a strip 300 advancing along the direction Z (FIG. 1c) by means of a shear 200 according to an embodiment of the invention substantially follow those of a shear according to the prior art with opposed rotating drums and can be summarized as follows.

After introducing the end of strip 300 into the gap between the drum 101 and the drum 101′ in their open position, the first drum 101 and the second drum 101′ are rotated into the open position, and then brought closer to each other (by moving one or both of them along the direction Y) and placed in the closed position, wherein finally the strip 300 is advanced along the direction Z, and wherein the rotation of the drums 101 and 101′ and the simultaneous advancing of the strip 300 result in the cutting of the strip 300 into portions the lengths of which depend, among other things, on the advancement speed of the strip 300 synchronized with the peripheral speeds of the knives 103 and 103′, respectively, wherein the drums 101 and 101′ are brought closer to each other by eccentric means, which allow the cutting to take place before the drums 101 and 101′ (and the respective knives 103 and 103′) are again moved away from each other as well as from the transiting product 300.

Instead, the adjustment modes of the gap G can be summarized as follows.

The first step involves releasing the blade 103 by translating the locking element 130 towards the outside of the seat 104. Next, the pressurized hydraulic fluid is introduced into the first chamber 106 or the second chamber 107 according to whether the gap G between blades 103 and 103′ must be increased or decreased, respectively.

Finally, the locking element 130 is moved back and reinserted into the seat 104, thereby locking the blade 103 in the position previously defined by the translation of the adjustment wedge 105.

Finally, it is worth noting that, according to an embodiment of the device 100 and/or of the respective shear 200, the gap G between said first knife 103 and second knife 103′ is adjustable to be equal to or greater than 0.00 mm.

Preferably the gap G is adjustable so that it is equal to or greater than 0.00 mm and less than 2.50 mm.

The excursion of the blade 103 in the TP1-TP2 direction (and thus in the direction Z of advancement of the strip 300) may be, for example, 0.65 mm (said value being non-binding in any case), wherein in a shear 200 comprising the first drum 101 and the second drum 101′, both with an adjustment wedge 105 and 105′ respectively, the gap G may reach, for example, 1.3 mm (value being non-binding in any case).

Preferably, the gap can be adjusted for thinner thicknesses by means of a shear according to the present invention in which only one of first drum 101 and second drum 101′, opposed to each other, is equipped with an adjustment wedge 105 for adjusting the tangential or circumferential position of the blade 103 and thus the gap G between the blades 103 and 103′.

We have thus demonstrated by means of the detailed description of the embodiments shown in the drawings given above that the present invention makes it possible to achieve the desired results and overcome or at least limit the drawbacks found in the prior art.

In particular, the present invention makes available a rotating drum cutting device comprising an innovative solution which:
can be implemented at low cost and by means of simple, fast operations on shear drums of different types and sizes;
allows adjustment of the gap between opposed drum blades of a shear in times compatible with production requirements;
guarantees a precise and long-lasting adjustment of said gap, thus avoiding in-process readjustments of the gap as previously set and adjusted.

Although the present invention is explained above by means of a detailed description of the embodiments thereof shown in the drawings the present invention is obviously not limited to the embodiments described above and shown on the drawings; on the contrary, the object of the present invention also comprises all the variants and/or changes to the embodiments described and shown on the accompanying drawings that will be apparent and immediate to a person skilled in the art.

The scope of protection of the present invention is thus defined by the claims.

1. A drum cutting device, e.g., for shears adapted to cut flat metal products advancing along a direction substantially parallel to their longitudinal direction of extension, said device being adapted to cut said flat metal products transversely relative to their direction of advancement, wherein said device comprises at least one drum adapted to be rotated and diametrically delimited by a cylindrical surface and containing a blade or knife partially protruding from said cylindrical surface, wherein said blade or knife is partially housed in a seat of said drum and extends longitudinally along a direction substantially parallel to a rotation axis X of said drum, wherein said device comprises an adjustment wedge also housed at least partially in said seat of said drum, wherein a direction of extension of said adjustment wedge is substantially parallel to the rotation axis (X) of said drum and a thickness of said adjustment wedge transversely to its direction of extension continuously varies along said direction of extension from a minimum thickness to a maximum thickness, wherein said adjustment wedge is positioned relative to said blade or knife so that a translation of said adjustment wedge parallel to its direction of extension in a first direction of translation results in a peripheral tangential translation of said blade or knife in a first direction of peripheral tangential translation, while the translation of said adjustment wedge in a second direction of translation opposite to the first one results in the peripheral tangential translation of said blade or knife in a second direction of peripheral tangential translation TP2 opposite to the first one, said device comprising translation means for the translation of said adjustment wedge in said two opposite directions of translation, wherein said translation means are arranged on said drum,
characterized in that said translation means are of a hydraulically actuated type and adapted to subject the opposite ends of said adjustment wedge to a hydraulic fluid pressure.

2. The device according to claim 1, wherein said translation means are arranged inside the drum.

3. The device according to claim 1, wherein said translation means comprise a first chamber and a second chamber respectively positioned inside the drum at a first end and a second end of said adjustment wedge, and wherein an introduction of pressurized hydraulic fluid into said first chamber or in said second chamber, by means of a hydraulic circuit comprising said first chamber and second chamber, results in the translation of said adjustment wedge in said first direction of translation or in said second direction of translation, respectively.

4. The device according to claim 3, wherein there are provided a first thrust element and a second thrust element housed respectively in said first chamber and said second chamber so that the introduction of said pressurized hydraulic fluid into said first chamber or said second chamber results respectively in the translation of said first thrust element or said second thrust element and thus respectively in a thrust against said first end of said adjustment wedge by said first thrust element in said first direction of translation or in a thrust against said second end of said adjustment wedge by said second thrust element in said second direction of translation.

5. A The device according claim 3, wherein said first and second chambers are placed in communication with an outside of said device respectively by means of a first hydraulic duct and a second hydraulic duct obtained at least partially inside said drum, and wherein said first hydraulic duct and said second hydraulic duct lead respectively into a first hydraulic port and a second hydraulic port accessible from an outside of said drum for the introduction of a pressurized hydraulic fluid respectively into said first chamber and said second chamber and for a discharge of said pressurized hydraulic fluid respectively from said first chamber and said second chamber.

6. The device according to claim 5, wherein said first hydraulic port and second hydraulic port are positioned on a rotating joint adapted to support rotating parts of said device.

7. The device according to claim 5, wherein said first chamber and said second chambers are placed in communication with the outside of said device also respectively by means of a third hydraulic duct and a fourth hydraulic duct obtained at least partially inside said drum, and wherein said third hydraulic duct and said fourth hydraulic duct lead respectively into a third hydraulic port and a fourth hydraulic port accessible from the outside of said drum for the introduction of a pressurized hydraulic fluid respectively into said first chamber and said second chamber and for the discharge of said pressurized hydraulic fluid respectively from said first chamber and said second chamber.

8. The device according to claim 7, wherein said first hydraulic port and second hydraulic port are positioned on a rotating joint adapted to support rotating parts of said device; and wherein said third hydraulic port and fourth hydraulic port are positioned on a rotating part of a hub of said device different from said rotating joint.

9. The device according to claim 1, wherein there is provided an indicator of position of said adjustment wedge positioned at least partially within the drum.

10. A method for cutting flat metal products advancing along a direction substantially parallel to their direction of longitudinal extension, said method being performed by a device by means of which said flat metal products are cut transversely relative to their direction of advancement, characterized in that said device is a device according to claim 1, thus wherein the rotation of said at least one drum results in an impact of said blade or knife against a flat metal product and thus ultimately in a cutting of said flat metal product transversely to its direction of advancement, and wherein the translation of said adjustment wedge in said two opposite directions of translation with consequent peripheral tangential translation of said blade is achieved by means of said hydraulically actuated type translation means arranged aboard said drum.

11. The method according to claim 10, wherein said translation means comprise a first chamber and a second chamber respectively positioned inside the drum at a first end and a second end of said adjustment wedge, and wherein the translation of said adjustment wedge in said first direction of translation or in said second direction of translation is achieved by introducing a pressurized hydraulic fluid into said first chamber or into said second chamber.

12. A drum shear for cutting flat metal products advancing along a direction substantially parallel to their direction of longitudinal extension, said drum shear being adapted to cut said flat metal products transversely relative to their direction of advancement, said drum shear comprising a first cutting device and a second cutting device comprising respectively a first drum and a second drum, diametrically delimited respectively by a first cylindrical surface and a second cylindrical surface, and a first blade or knife and a second blade or knife fixed respectively to said first drum and to said second drum and protruding respectively from said first drum and from said second drum, wherein said first cutting device and said second cutting device are reciprocally positioned so as to define a space for a passage of said flat metal products during their advancement, wherein with said first cutting device and said second cutting device appropriately positioned, a rotation of said first drum and said second drum results in a cutting of said flat metal product by means of a substantially simultaneous action of said first blade and said second blade; wherein at least said first cutting device is a device according to claim 1.

13. The drum shear according to claim 12, wherein at least one of said first cutting device and second cutting device is translatable along a direction of translation Y perpendicular to the rotation axis X of the respective first drum away from or towards said second cutting device.

14. The drum shear according to claim 12, wherein the gap between said first knife and second knife is adjustable so as to be equal to or greater than 0.00 mm.
